(19) United States
(12) Patent Application Publication
(10) Pub. No.: US 2016/0140575 A1
(43) Pub. Date: May 19, 2016

(54) Multidimensional Customer Relationship Model

(71) Applicant: Kunal Sorout, Palwai/Haryana (IN)

(72) Inventor: Kunal Sorout, Palwai/Haryana (IN)

(21) Appl. No.: 14/542,914

(22) Filed: Nov. 17, 2014

(51) Int. Cl. G06Q 30/02; G06Q 10/06; G06F 17/30

(52) U.S. Cl. CPC G06Q 30/0201; G06F 17/3053; G06Q 10/067

(57) ABSTRACT

Techniques are described for updating a multidimensional customer relationship model (MRCM). The MRCM can be configured to store a plurality of causal attribute that describe different factors relevant to customer satisfaction and customer loyalty. In some examples, the MRCM can be analyzed to provide recommend actions to the company. The recommended actions can include actions to improve the customer relationship, actions to improve revenue, and actions to identify prospective customers.

### BACKGROUND

Customers are the lifeline of any business. As a result, businesses value their customers and place their best efforts to retain their customers. Best efforts can include monitoring customer satisfaction and customer engagement levels to determine whether the customer is satisfied. When a customer is not satisfied, the business can take steps to remedy the situation. However, satisfied customer does not necessarily mean that the customer will remain loyal. In today's competitive business environment, customers while satisfied may still switch providers/merchants due to special offers or incentives by competitors. Thus, it is important to determine whether a customer will remain loyal if they are approached by competing businesses.

### SUMMARY

In one embodiment, a computer-implemented method calculates, by the processor, a score for a causal attribute based on raw customer data associated with a customer, the causal attribute belonging to a collection of causal attributes that include at least one of an advocacy attribute, a satisfaction attribute, a branding attribute, and a new value creation attribute. The method then updates, by the processor, a multidimensional customer relationship model that is associated with the customer with the calculated score for the causal attribute, the multidimensional customer relationship model being configured to store the collection of causal attributes. The method then calculates, by the processor, a customer relationship score based on the collection of causal attributes of the multidimensional customer relationship model. The method then stores, by the processor, the customer relationship score in the multidimensional customer relationship model.

In one example, the causal attribute is the advocacy attribute and calculating the score for the causal attribute comprises analyzing, by the processor, at least one of the following parameters from the raw customer data to generate an advocacy score: (1) a first number of a references provided by the customer, (2) a second number of testimonials provided by the customer, (3) a third number of case studies published by the customer, and (4) a fourth number of speaker invitations accepted by the customer.

In another example, the causal attribute causal attribute is the satisfaction attribute and calculating the score for the causal attribute comprises analyzing, by the processor, at least one of the following parameters from the customer raw data to generate a satisfaction score: (1) a satisfaction survey associated with the customer, (2) at least one complaint submitted by the customer, and (3) at least one risk score associated with a phase of a project associated with the customer. The risk score can be weighted based on a severity state of a risk and the duration of the risk.

In another example, the method further comprises determining, by the processor, a revenue received from the customer and providing, by the processor, a recommended action based on the customer relationship score of the multidimensional customer relationship model and the revenue.

In another example, the method further includes determining, by the processor, that the customer relationship score is above a predefined threshold, identifying, by the processor, a plurality of prospective customers that are connected with the customer, and providing, by the processor, a recommended action to request the customer advocate a service to at least one of the plurality of prospective customers.

In another embodiment, a non-transitory computer readable storage medium stores one or more programs comprising instructions for calculating a score for a causal attribute based on raw customer data associated with a customer, the causal attribute belonging to a collection of causal attributes that include at least one of an advocacy attribute, a satisfaction attribute, a branding attribute, and a new value creation attribute, updating a multidimensional customer relationship model that is associated with the customer with the calculated score for the causal attribute, the multidimensional customer relationship model being configured to store the collection of causal attributes, calculating a customer relationship score based on the collection of causal attributes of the multidimensional customer relationship model, and storing the customer relationship score in the multidimensional customer relationship model.

In another embodiment, a computer implemented system comprises one or more computer processors and a non-transitory computer-readable storage medium. The non-transitory computer-readable storage medium comprises instructions, that when executed, control the one or more computer processors to be configured for calculating a score for a causal attribute based on raw customer data associated with a customer, the causal attribute belonging to a collection of causal attributes that include at least one of an advocacy attribute, a satisfaction attribute, a branding attribute, and a new value creation attribute, updating a multidimensional customer relationship model that is associated with the customer with the calculated score for the causal attribute, the multidimensional customer relationship model being configured to store the collection of causal attributes, calculating a customer relationship score based on the collection of causal attributes of the multidimensional customer relationship model, and storing the customer relationship score in the multidimensional customer relationship model.

The following detailed description and accompanying drawings provide a better understanding of the nature and advantages of the present disclosure.

### BRIEF DESCRIPTION OF THE DRAWINGS

FIG. 1 illustrates a system according to one embodiment;

FIG. 2 illustrates a MCRM according to one embodiment;

FIG. 3 illustrates an advocacy engine according to one embodiment;

FIG. 4 illustrates a satisfaction and alignment engine according to one embodiment;

FIG. 5 illustrates a new value creation engine according to one embodiment;

FIG. 6 illustrates an exemplary revenue score table according to one embodiment;

FIG. 7 illustrates a system for providing recommended actions according to one embodiment;

FIG. 8 illustrates a chart for providing a recommended course of action for a customer according to one embodiment;

FIG. 9 illustrates a graph for selecting prospective customers according to one embodiment;

FIG. 10 illustrates a process for updating a multidimensional customer relationship model according to one embodiment; and

FIG. 11 illustrates an exemplary computer system according to one embodiment.

### DETAILED DESCRIPTION

In the following description, for purposes of explanation, numerous examples and specific details are set forth in order to provide a thorough understanding of the present disclosure. It will be evident, however, to one skilled in the art that the present disclosure as expressed in the claims may include some or all of the features in these examples alone or in combination with other features described below, and may further include modifications and equivalents of the features and concepts described herein.

Disclosed herein are techniques for analyzing customer raw data to generate a multidimensional customer relationship model. The multidimensional customer relationship model (MCRM) can be configured to store a plurality of causal attributes that describe different factors relevant to customer satisfaction and customer loyalty. A company can utilize the MCRM to predict how satisfied and loyal a customer is with the company. In some examples, the causal attributes can include an advocacy attribute (i.e., measurement of how much the customer is an advocate of the company), a satisfaction attribute (i.e., measurement of customer satisfaction with respect to the company), a branding attribute (i.e., measurement of how effective company efforts on branding are to the customer), and new value creation attribute (i.e., measurement of the value that associating with the company has created for the customer from the customer's perspective). In some embodiments, the MCRM can be analyzed provided recommended actions that can be implemented by the sales or marketing team of the company. Recommended actions can include engaging more with the customer, sell more to the customer, or to perform an in-depth review of the customer. If customer loyalty and satisfaction is high, the recommended actions can also be to engage with the customer to see whether the customer can be an advocate of the company when speaking with prospective customers.

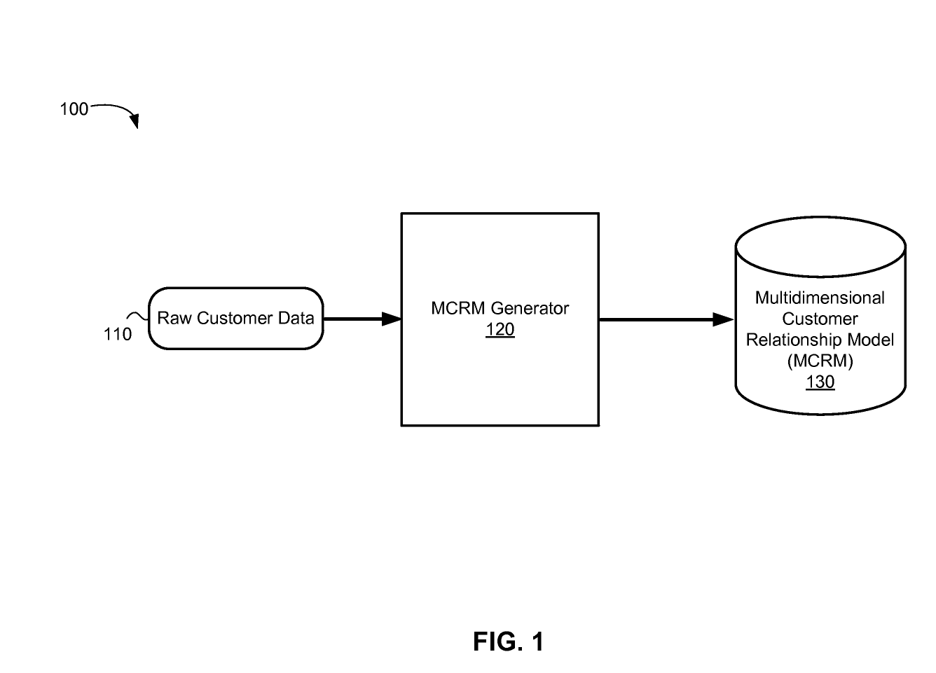

FIG. 1 illustrates a system according to one embodiment. System 100 is configured to generate a multidimensional customer relationship model (MCRM). System 100 includes MCRM generator 120 which can receive raw customer data 110. MCRM generator 120 is configured to process raw customer data 110 to generate MCRM 130. Raw customer data 110 can be collected using aggregation tools. Exemplary raw customer data 110 can include customer satisfaction (CSAT) surveys (or other surveys used to measure customer satisfaction), engagement level feedback (ELF) surveys (or other surveys used to measure customer engagement), customer references, customer testimonials, case studies published by the customer, speaker invitation acceptances by the customer, customer complaints, customer revenue numbers, and joint ventures with the customer. Some parts of the raw customer data 110 can be private information that has been collected by the company during the course of business with the customer. Other parts of the raw customer data 110 can be public information that is collected through public searches performed by the aggregation tool.

### The Multidimensional Relationship Model

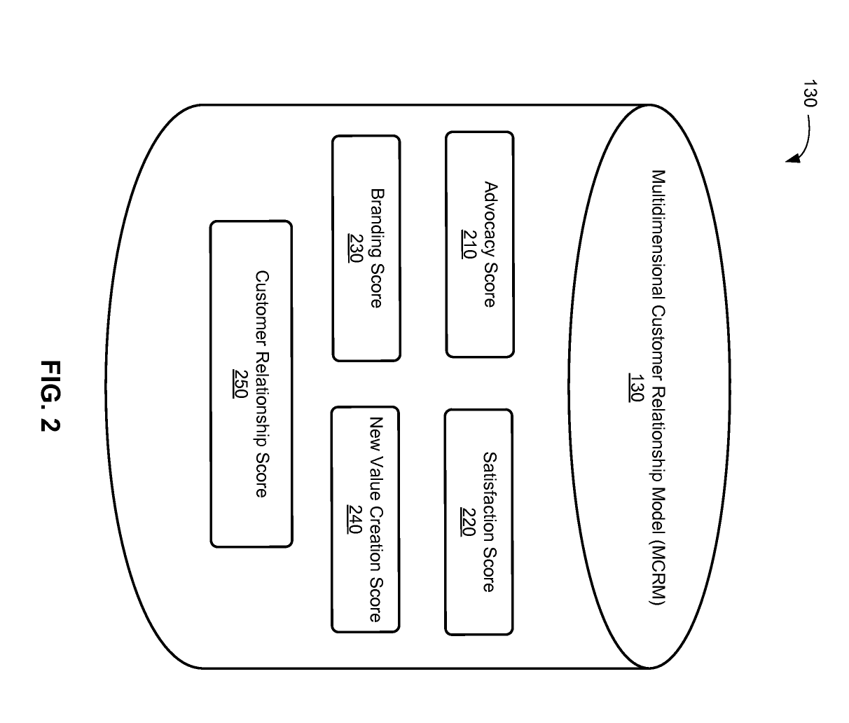

FIG. 2 illustrates a MCRM according to one embodiment. MCRM 130 is configured to store a plurality of scores that represent the different factors that are related to the customer relationship. MCRM 130 includes advocacy score 210 that quantitatively measures the customer advocacy. Customer advocacy is a measurement of whether the customer would publically support the company. In one embodiment, advocacy score 210 can be from the company's perspective meaning that advocacy score 210 is based on data that has been generated by the company and not by the client. In other embodiments, advocacy score 210 can be generated based on client-generated data or a combination of the two.

MCRM 130 further includes satisfaction score 220 that quantitatively measures customer satisfaction. Customer satisfaction describes how happy or satisfied the customer is with the company. In some examples, customer satisfaction can also take into consideration the degree in which the customer feels the company is aligned with the customer's interests. A customer may prefer to do business with a company which has the same goals as the customer. In some embodiments, surveys performed by the customer to measure the customer's satisfaction and alignment can be used to boost the satisfaction score 220. In some embodiments, customer complaints and customer projects that have been at risk can be used to decrease satisfaction score 220.

MCRM 130 further includes branding score 230 that quantitatively measures the successfulness of the company in developing a good brand in the eyes of the customer. A good brand typically includes attributes such as the ability to delivery messages clearly, credibility, motivational, and loyalty. In some embodiments, branding score 230 can be generated based on parameters such as the quality/frequency of customer communication, the types of customer communication available, the quality of presentations, the speed of responses and proposals, comprehensiveness of solutions suggestions, and overall brand experience. These parameters can be generated by the company, by the customer through customer surveys, or a combination of the two.

MCRM 130 further includes new value creation score 240. New value creation score 240 measures whether, from the customer's perspective, the company has created new value for the customer, either in terms of revenue, intellectual property, or other forms of value added. New value creation score 240 can be a subjective measurement that is based on whether the revenue benefit delivered by the company meets the customer's expectations. In some embodiments, new value creation score 240 can also take into consideration whether the company collaborated with the customer to generate new intellectual property.

MCRM 130 further includes customer relationship score 250. Customer relationship score 250 represents the overall relationship with the customer when taking into consideration the factors that are represented by advocacy score 210, satisfaction score 220, branding score 230, and new value creation score 240. In some embodiments, these factors can be weighted and averaged when they are combined to form customer relationship score 250. If raw customer data is not available for one of the scores, then the unavailable score is not factored into customer relationship score 250. In one embodiment, different customers of the company can apply different weightings to the factors when generating customer relationship score 250.

### Advocacy

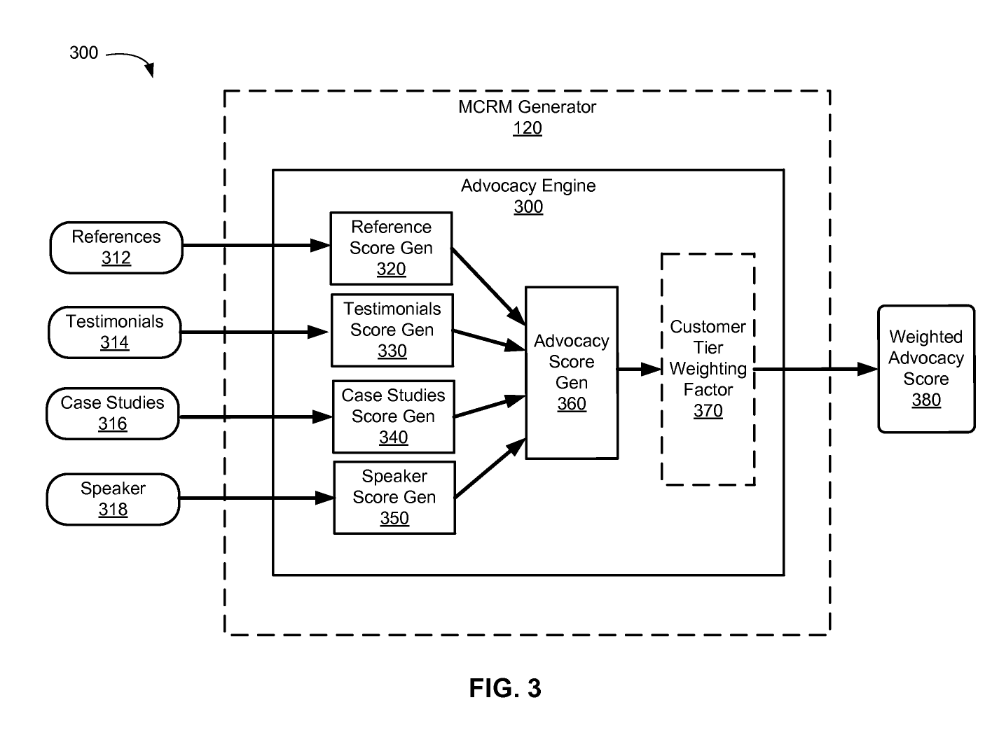

FIG. 3 illustrates an advocacy engine according to one embodiment. Advocacy engine 300 can belong to MCRM generator 120 and be configured to generate the advocacy score that is stored within MCRM 130. Advocacy engine 300 can include reference score generator 320, testimonials score generator 330, case studies score generator 340, and speaker score generator 350. Each generator can be configured to generate a score that's based on a type of raw customer data. Advocacy engine 300 further includes advocacy score generator 360 which is configured to combine the individual scores into an aggregated score (i.e., the advocacy score). In some embodiments, advocacy engine 300 can optionally include customer tier weighting factor 370. Customer tier weighting factor 370 can apply a weighting to the advocacy score that is based on the tier which the customer is a part of. For example, tier 1 customers can contain the company's most valued customers followed by tier 2 customers and tier 3 customers. In one example, a customer may be valued based on the revenue which the customer brings to the company. In other examples, value can be based on other factors such as potential revenue, potential growth, or the relationship between the customer and the company. In one embodiment, customer tier weighting factor can apply a multiplier to the advocacy score to create weighted advocacy score 380. In one example, tier 1 customers can have a multiplier of 1×, tier 2 customers can have a multiplier of 0.7×, and tier 3 customers can have a multiplier of 0.4×. In other examples, the number of tiers and the multipliers associated with each tier can vary.

Reference score generator 320 can be configured to generate a reference score that is based on the positive references that have been provided by the customer. Typically, a customer can provide a positive reference to colleagues, friends, or prospective customers, which can help the company secure new customers. The company can track these positive references and store them as part of the raw customer data. In some embodiments, reference score generator 320 can generate a reference score based on the number of positive references provided by the customer during a predefined period of time. In one embodiment, reference score generator 320 can assign a reference score by using an equation that takes the number of positive references during the predefined period of time divided by the threshold number of references and multiplied by 100%. For example, let's assume the company expects that customers will provide one positive reference per quarter. In the past quarter, the customer has provided two positive references. Reference score generator 320 detects that the customer has provided two references. Two references divided by the threshold (one reference) and then multiplied by 100% means that the reference score in this example is 200%.

Testimonials score generator 330 can be configured to generate a testimonials score that is based on the number of testimonials that have been received from the customer. A testimonial is a statement made by the customer that is related to a product that belongs to the company. A customer can provide testimonials for products through blogs, published articles, joint statements, e-interviews, interviews, and other forms of media. In one embodiment, testimonials score generator 330 can generate a testimonials score based on the total number of testimonials that have been provided by the customer in the past quarter (or other predefined period of time). For example if there have been 4 testimonials in the past quarter, then testimonials score generator 330 can assign a value of 400% to the testimonials score. In another embodiment, testimonials score generator 330 can generate a testimonials score based on the total number of testimonials per product that have been provided by the customer. For example if the customer has provided 3 testimonials for product A and a 1 testimonial for product B, then testimonials score generator 330 can generate a testimonials score based on the smallest number in the set, which would be 1 here since product B has 1 testimonial. Thus, testimonials score generator 330 can assign a testimonials score of 100%. In some embodiments, the person providing the testimonial can factor into the testimonials score. For example, testimonials score generator 330 can provide a weighting factor to the testimonials score based on the person giving the testimonial. For instance if the person is the CEO, then a weighting factor of 1× can be applied to the testimonial score. Alternatively if the person if the CXO, then a weighting factor of 0.8× can be applied to the testimonial score.

Case studies score generator 340 can be configured to generate a case studies score that is based on the number of case studies that have been published by the customer. A case study is a published study that is related to a customer project that is in the implementation stage. Case studies score generator 340 can generate a case studies score that is based on the number of published case studies from the customer. In one example, case studies score generator 340 can generate a case studies score that equates each published case study with a score of 100% and sums up the total of the published case studies to generate a case studies score. In some embodiments, the score associated with each case study can be weighted. For example if the case study is not updated, a weighting factor of 0.8× can be applied to the score associated with the given case study. For instance if a published case study is not updated, then a score of 80% can be assigned to the published cast study. In some embodiments, other types of studies and publications can be included, such as leadership articles.

Speaker score generator 350 can be configured to generate a speaker score that is based on the number of speaker invitations that have been accepted by the customer. The number of speaker invitations can be measured on a quarterly basis or other predefined period of time. In one embodiment, speaker score generator 350 can generate a speaker score where each speaker is assigned a score of 100% and the total for all the speakers is summed up. In some embodiments, a weighting factor that is based on the seniority and impact of the speaker can also be applied. For example, a score of 100% can be assigned when the speaker is the CEO, a score of 80% can be assigned when the speaker is the CXO, and a score of 60% can be assigned when the speaker is someone other than the CEO and the CXO.

Advocacy score generator 360 is configured to generate the advocacy score from the scores generated by reference score generator 320, testimonials score generator 330, case studies score generator 340, and speaker score generator 350. In one embodiment, advocacy score generator 360 can take an average of the scores to determine the advocacy score. In other embodiments, custom weighting factors can be applied to the four scores based on the important that the company places on each parameter. For example if the company values references and testimonials over case studies and speakers, then the reference score can be multiplied by 40%, testimonials score can be multiplied by 40%, case studies score can be multiplied by 10%, and speaker score can be multiplied by 10%. The total is 100%. In other examples, other weighting factors can be applied to the different scores.

### Satisfaction and Alignment

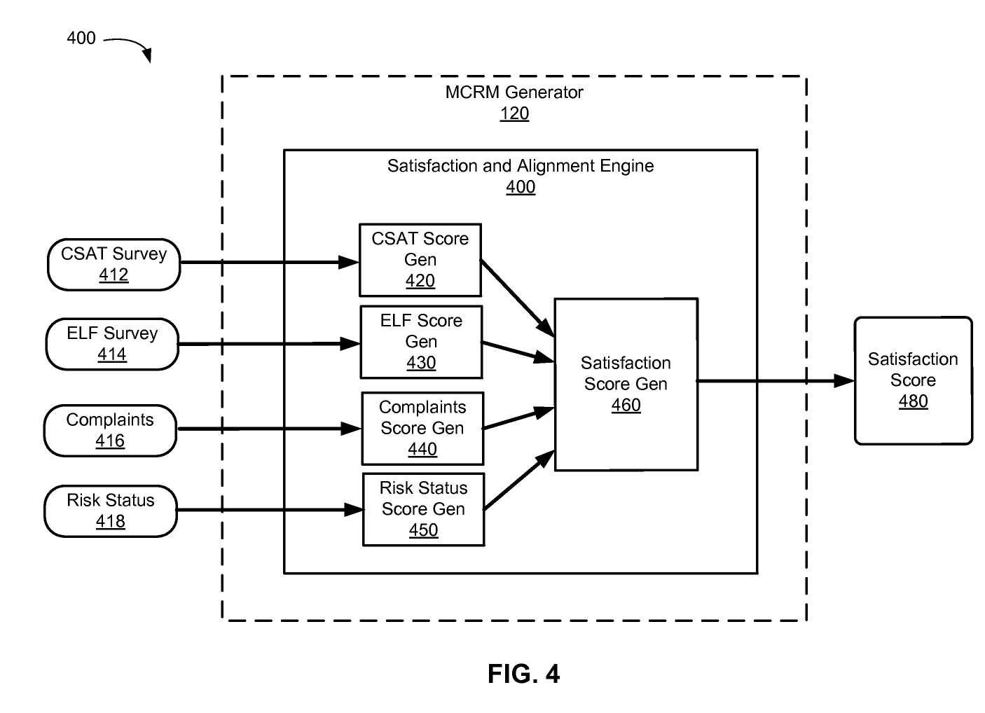

FIG. 4 illustrates a satisfaction and alignment engine according to one embodiment. Satisfaction and alignment engine 400 can belong to MCRM generator 120 and be configured to generate the satisfaction score that is stored within MCRM 130. Here, satisfaction and alignment engine 400 can generate the satisfaction score by analyzing raw customer data that includes CSAT survey 412, ELF survey 414, complaints 416, and the risk status 418 of customer projects. In other embodiments, different types of surveys and risk analysis can be received by satisfaction and alignment engine 400 and processed to generate the satisfaction score.

Satisfaction and Alignment engine 400 can include CSAT score generator 420, ELF score generator 430, complaints score generator 440, and risk status score generator 450. Each generator can be configured to generate a score that's based on a type of raw customer data. Satisfaction and alignment engine 400 further includes satisfaction score generator 460 which is configured to combine the generated scores into an aggregated score (i.e., the satisfaction score 480). In some embodiments, satisfaction and alignment engine 400 can optionally include customer tier weighting factor (not shown). The customer tier weighting factor can apply a weighting to the advocacy score that is based on the tier which the customer is a part of, as described in FIG. 3.

CSAT score generator 420 can be configured to generate a CSAT score that is based on CSAT survey 412. CSAT survey 412 is a customer satisfaction report that describes how satisfied the customer is with the company. The customer satisfaction report can be generated from feedback provided by the customer. CSAT score generator 420 can generate a CSAT score based on a score associated with CSAT survey 412. For example, a CSAT survey score=6.1 can be equated to a CSAT score of 100%, a CSAT survey score between 5.5 and 6.0 can be equated to a CSAT score of 80%, a CSAT survey score between 5.0 and 5.5 can be equated to a CSAT score of 60%, a CSAT survey score between 4.0 and 5.0 can be equated to a CSAT score of 40%, a CSAT survey score between 3.0 and 4.0 can be equated to a CSAT score of 20%, and a CSAT survey score less than 3.0 can be equated to a CSAT score of 0%. In one embodiment, CSAT score generator 420 can use ELF survey 414 when generating the CSAT score. For example, ELF survey 414 can be used when CSAT survey 412 is unavailable (e.g., the customer has not responded yet) or when CSAT survey 412 is outdated (e.g., older than 12 months).

ELF score generator 430 is configured to generate an ELF score that is based on ELF survey 414. ELF survey 414 is a survey that provides feedback on the engagement level provided by the company. In some examples, ELF survey 414 can include multiple parameters that each have a rating attributable to the parameter. Exemplary parameters include completeness of deliverables, quality of product delivered, quality of documentation, disk/issue management capability, adherence to SLA, proactive communication on progress, delivery within committed cost, handling transition of resources, commitment demonstrated by the team, team adapting to your culture, ability/effectiveness of verbal communication, ability/effectiveness of written communication, domain knowledge, and technical expertise.

In one embodiment, ELF score generator 430 can perform a series of steps to calculate the ELF score. The first step can be to determine when ELF survey 414 was obtained. If ELF survey 414 is more than six months old (or some other predefined period of time), then ELF score generator 430 can set the ELF score as zero. The second step can be to determine the number of parameters in ELF survey 414 that have a score less than 4 (or some other predefined value). If the number of parameters in ELF survey that have a score less than 4 is greater than 7 (or some other predefined number), ELF score generator 430 can set the ELF score to zero. In the scenario where ELF survey 414 is less than six months old and there are fewer than 7 parameters that have a score less than 4, ELF score generator 430 can examine the overall satisfaction score that is stored in ELF survey 414. If the overall satisfaction score is less than 4.9, then ELF score generator 430 can set the ELF score to 0%. Similarly if the overall satisfaction score is between 5 and 6, then the ELF score generator 430 can set the ELF score to 80%. Lastly if the overall satisfaction score is greater than 6, then ELF score generator 430 can set the ELF score to 100%.

Complaints score generator 460 is configured to generate a complaints score based on complaints 416. Each complaint in complaints 416 can include a creation date specifying the date in which the complaint was created and a resolution flag specifying whether the complaint was resolved to the customer's satisfaction. In one embodiment, a process flow can be performed on each complaint to generate a score for each complaint. The process flow can generate a higher score for the complaint based on the escalation level of the complaint. In one embodiment, a complaint can be assigned a score of 1.5 if more than seven days pass before a response is provided to the complaint. If no progress has occurred to resolve the complaint for a period of 21 days, then 2.0 points can be added to the score of the complaint. If a term within the service level agreement (SLA) is breached by more than 15 days due to the complaint, then an additional 2.5 points is added to the score of the complaint. Once the score of the complaint is calculated, the score can be converted to a complaints score based on a table. For example if the score is between 5-7, then the complaints score is 100%. If the score is between 4-5, then the complaints score is 80%.

Risk analysis score generator 450 is configured to generate a risk analysis score based on risk status 418. Risk status 418 measures the risk level of a customer project and the period of time in which the customer project has been at the specified risk level. Based on risk level and the period of time, risk status score generator 450 can generate a risk score. In one embodiment, risk analysis score generator 450 can assign a value of one to the risk score when the risk status is high and a value of two to the risk score when the risk status is critical. Risk analysis score generator 450 can then apply a multiplier to the assigned risk score that is dependent on the duration in which the project has been at that risk level. If the project has been at the specified risk level for less than 3 months, than a 0.4× multiplier can be applied. Alternatively if the project has been at the specified risk level for 3-6 months, then a 0.6× multiplier can be applied. If the project has been at the specified risk level for 6-12 12 months, then a 0.8× multiplier can be applied. If the project has been at the specified risk level for over 12 months, than a 1× multiplier can be applied. In other embodiments, other durations and multipliers can be applied.

Satisfaction score generator 460 can combine the CSAT score, ELF score, complaints score, and risk status score to calculate the net satisfaction and alignment score (i.e., satisfaction score 480). In one embodiment, the CSAT and ELF scores can be added to satisfaction score 480 while the complaints score and the risk score can be subtracted from satisfaction score 480.

### Branding

MCRM generator 120 can include a branding engine that is configured to generate branding score 230. In one embodiment, the branding engine can process the CSAT survey used by satisfaction and alignment engine 400 to also calculate branding score 230. The branding engine can average one or more parameters from the CSAT survey that are related to branding to create the branding score. The relevant parameters can be simply averaged or weighted before being averaged. Exemplary branding parameters (which can each have an associated score between 1 and 7) include:
i. quality and frequency of customer communication—emails/meetings with senior management
ii. quality and quantity of customer interaction mechanisms—conclaves, forums, customer advisory board, workshops
iii. through leadership initiatives for customers—CXO roundtables and website thought papers
iv. quality of presentation/demonstration of solutions
v. speed of proposals/responses
vi. comprehensiveness of solution suggested
vii. overall brand experience

### New Value Creation

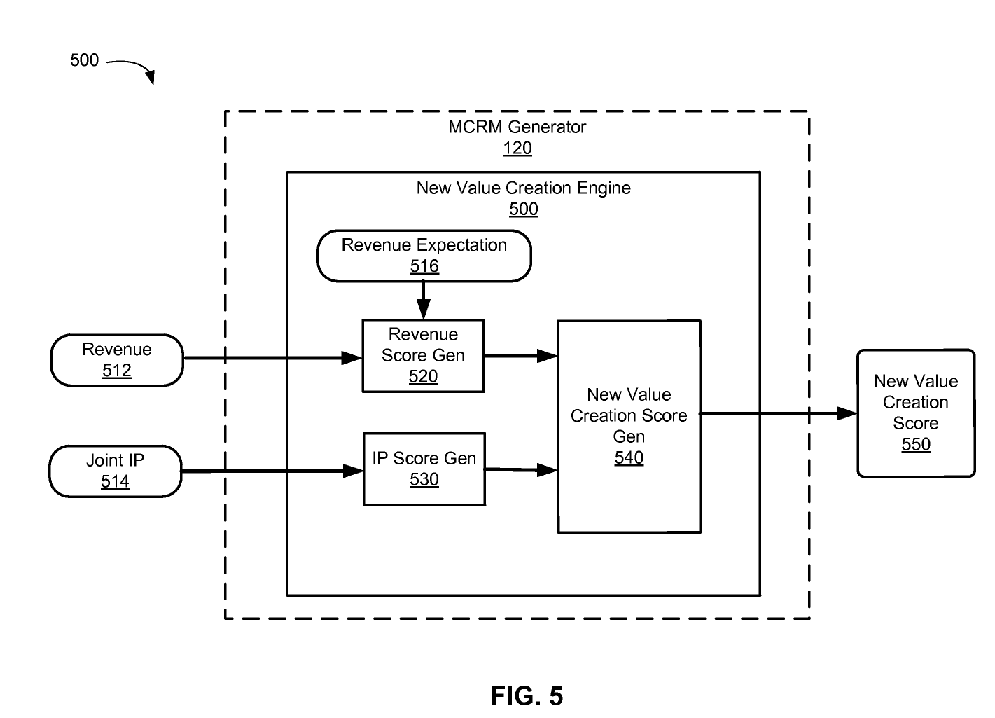

FIG. 5 illustrates a new value creation engine according to one embodiment. New value creation engine 500 can belong to MCRM generator 120 and be configured to generate new value creation score 240 of MCRM 130. Here, new value creation engine 500 can generate new value creation score 240 by analyzing raw customer data that includes revenue 512 and joint IP 514. Revenue 512 can be a measurement of the revenue value that has been delivered by the company to the customer. The measurement can be the current revenue or projected revenue. Joint IP 514 can be a list of intellectual property that has been created from collaboration between the company and the customer.

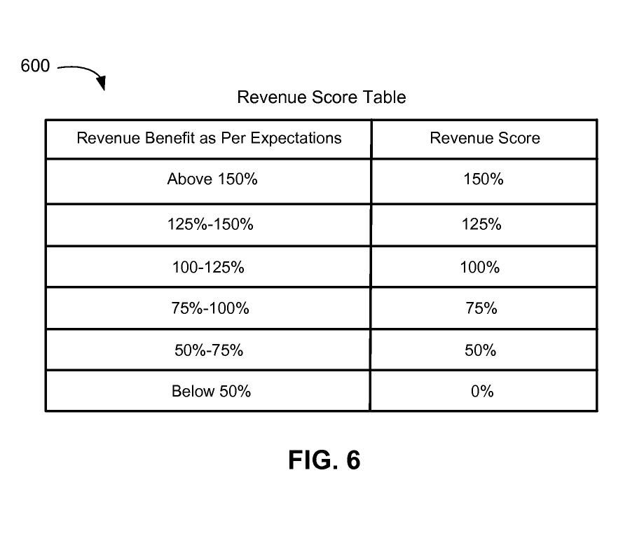

New value creation engine 500 can include revenue score generator 520. Revenue score generator 520 is configured to generate a revenue score based on revenue 512. In one embodiment, revenue score generator 520 can generate a revenue score by comparing revenue 512 with revenue expectation 516. Revenue expectation 516 can be the revenue that the customer expected. By comparing the expected revenue against the actual revenue, a revenue score can be generated. In one example, revenue score generator 520 can apply a revenue score table to calculate the revenue score. FIG. 6 illustrates an exemplary revenue score table according to one embodiment. Revenue score generator 520 can divide revenue 512 by revenue expectation 516 and multiply the result by 100% to calculate the revenue benefit as per expectations. Based on the revenue benefit per expectations, revenue score generator 520 can look up the revenue score from revenue score table 600.

New value creation engine 500 can further include IP score generator 530. IP score generator 530 can generate an IP score from joint IP 514. In one embodiment, IP score generator 530 can assign an IP score of 100% when there has been intellectual property created from the collaboration between the company and the customer. If there has been no intellectual property created, then IP score generator 530 can assign an IP score of 0%.

New value creation engine 500 further includes new value creation score generator 540. New value creation score generator 540 can be configured to combine the revenue score from revenue score generator 520 and the IP score from IP score generator 530. In one embodiment, new value creation score generator 540 can generate new value creation score 550 by summing the revenue score and the IP score. In other embodiments, new value creation score generator 540 can combine the revenue score and the IP score using other techniques to generate new value creation score 550.

MCRM generator 120 can be configured to combine the advocacy score, the new value score, the branding score, and the satisfaction score to generate the relationship score.

In one embodiment, MCRM generator 120 can average the four scores to generate the relationship score. In other embodiments, a weighting factor can be applied to each score before they are averaged. This allows certain factors to be weighted more heavily than other factors.

### Applications for MCRM

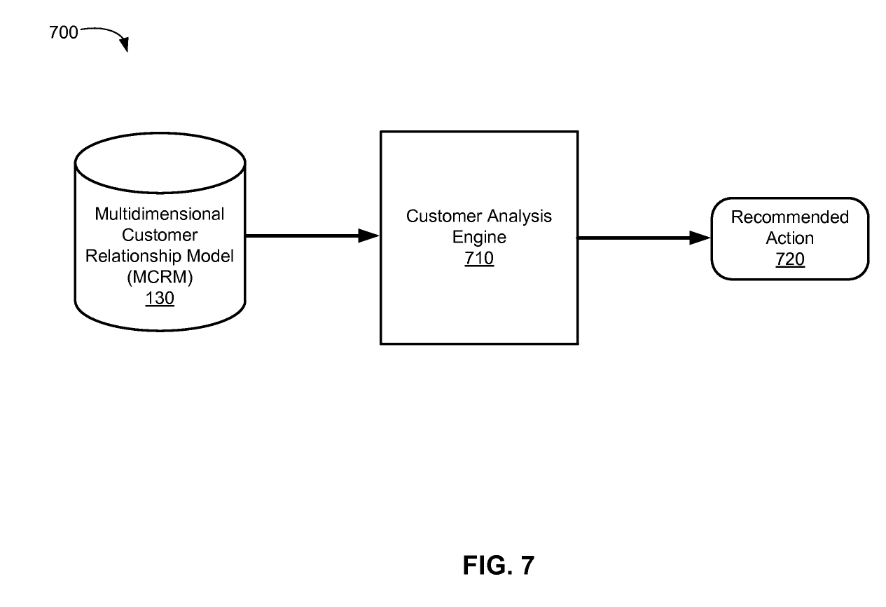

FIG. 7 illustrates a system for providing recommended actions according to one embodiment. System 700 includes customer analysis engine 710 which is configured to process MCRM 130 to generate recommended action 720. In some examples, customer analysis engine 710 can receive MCRMs that are associated with multiple customers before providing recommended action 720. In one example, recommended action 720 can be a recommended course of action for a customer. In another example, recommended action 720 can identify prospective customers who have a high probability of becoming a new customer based their existing relationships with current customers.

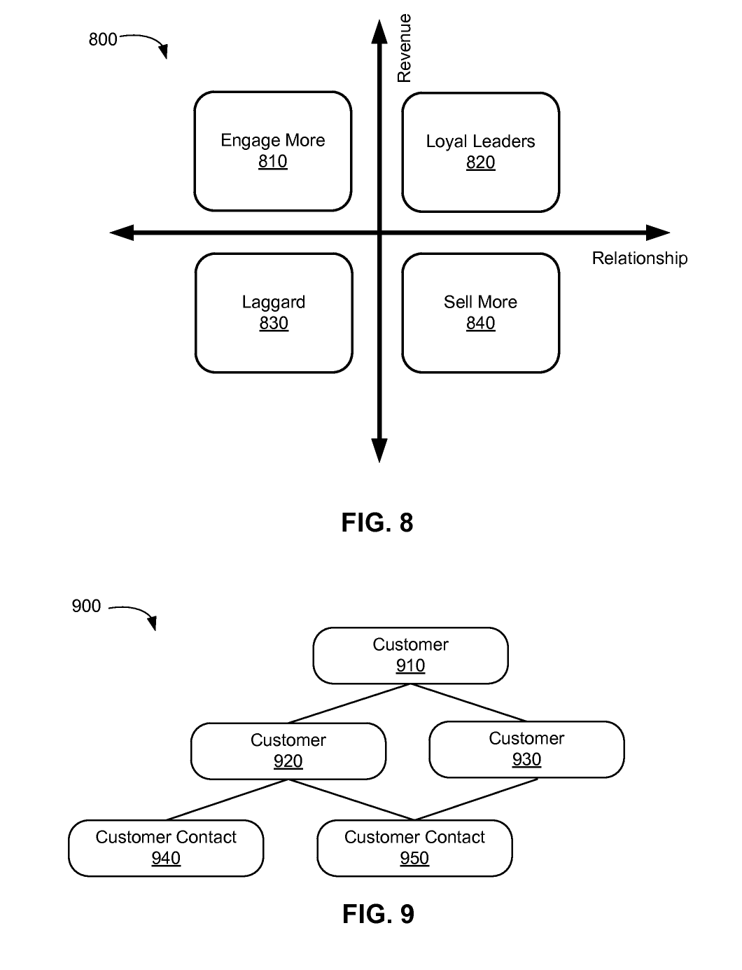

FIG. 8 illustrates a chart for providing a recommended course of action for a customer according to one embodiment. As shown, chart 800 is a two dimensional chart where the x-axis is the customer relationship score for a given customer and the y-axis is the company revenue that can be attributable to the customer. Customer analysis engine 710 can identify which quadrant a customer lies within chart 800 based on the customer relationship score associated with the MCRM of the customer and the revenue numbers of the customer. Depending on the quadrant, customer analysis engine 710 can provide a recommended course of action with the customer. Marketing and sales personnel within the company can optionally execute the recommended course of action. In some embodiments, the customer relationship score and revenue numbers can be normalized based on the customer relationship score and revenue numbers of other customers.

If the customer relationship score is negative but the revenue is positive (e.g. quadrant 810), chart 800 can provide a recommendation to engage more with the customer.

Engaging more with the customer can hopefully improve relationships with the customer and ultimately improve the customer relationship score. If the customer relationship score is positive and the revenue is positive (e.g., quadrant 820), then the customer is classified as a loyal leader. As a result, chart 800 can provide a recommendation to stay with the regular course of business since the customer relationship is healthy and the revenue stream from the customer is also healthy. If the customer relationship score is negative and the revenue is negative (quadrant 830), then the customer is classified as a laggard. Laggards are customers where the relationship and the revenue stream generated by the customer are both poor. A recommendation can be made to terminate the relationship with the customer. If the customer relationship score is positive but the revenue is negative (quadrant 840), then a recommended action can be made to conduct more business with the customer since the customer relationship is healthy but the revenue is low.

FIG. 9 illustrates a graph for selecting prospective customers according to one embodiment. As shown, graph 900 can plot the relationships with different customers and contacts of those customers. Each customer or customer contact can be represented as a node in graph 900. Customers and customer contacts that have an existing relationship can be connected by a line in graph 900. Each customer contact can be a prospective customer. Here, graph 900 includes customer 910 who is connected to customer 920 and 930. Customer 920 is connected to customer contacts 940 and 950 while customer 930 is connected to customer contact 950.

In one embodiment, customer analysis engine 710 can be configured to analyze graph 900 and the MCRM that corresponds with each existing customer in graph 900 to identify one or more customer contacts which are ideal candidates to approach as prospective customers. For example, customer analysis engine 710 can apply various graph theory techniques to identify customer contacts which have maximum connections with existing customers having a healthy customer relationship value. Customer analysis engine 710 can provide a recommendation to approach the identified customer contacts to see whether they would be interested in joining as a new customer. Given that the identified customer contacts have existing relationships with customers who have a good relationship with the company, it is more likely that the identified customer contacts would become a client of the company versus other customer contacts who do not have relationships with customers having a good relationship with the company. Here, customer 920 and 930 can both have good customer relationship values stored in their corresponding MCRM. Based on the fact that customer contact 950 is connected to two customers who have good customer relations with the company (e.g., customer 920 and 930) versus customer contact 940 which has one customer who has good customer relations with the company (customer 920), customer analysis engine 710 can recommend customer contact 950 first, followed by customer contact 940. In some examples, customer analysis engine 710 can return a ranked list of customer contacts. The customer contacts can be ranked according to the likelihood of success for signing up the customer contact based on the customer contact's relationships with existing customers.

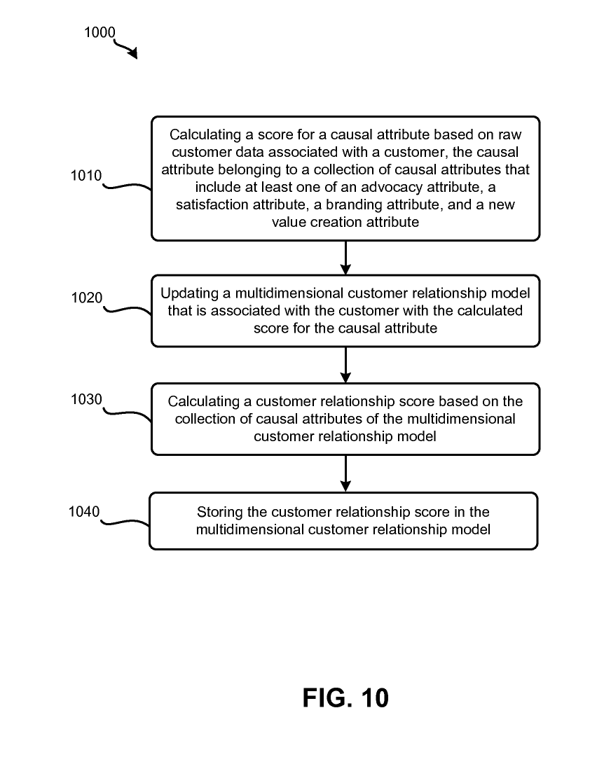

FIG. 10 illustrates a process for updating a multidimensional customer relationship model according to one embodiment. Process 1000 can be stored in computer readable code and executed by a processor. For example, process 1000 can be part of the computer readable code that is executed by MCRM generator 120 of FIG. 2. Process 1000 can begin by calculating a score for a causal attribute based on raw customer data associated with a customer, the causal attribute belonging to a collection of causal attributes that include at least one of an advocacy attribute, a satisfaction attribute, a branding attribute, and a new value creation attribute at 1010. Once the score is generated, process 1000 can continue by updating a multidimensional customer relationship model that is associated with the customer with the calculated score for the causal attribute at 1020. The multidimensional customer relationship model can be configured to store the collection of causal attributes plus a customer relationship score that aggregates the causal attributes. Process 1000 can continue by calculating the customer relationship score based on the collection of causal attributes of the multidimensional customer relationship model at 1030. Process 1000 can then continue by storing the customer relationship score in the multidimensional customer relationship model at 1040.

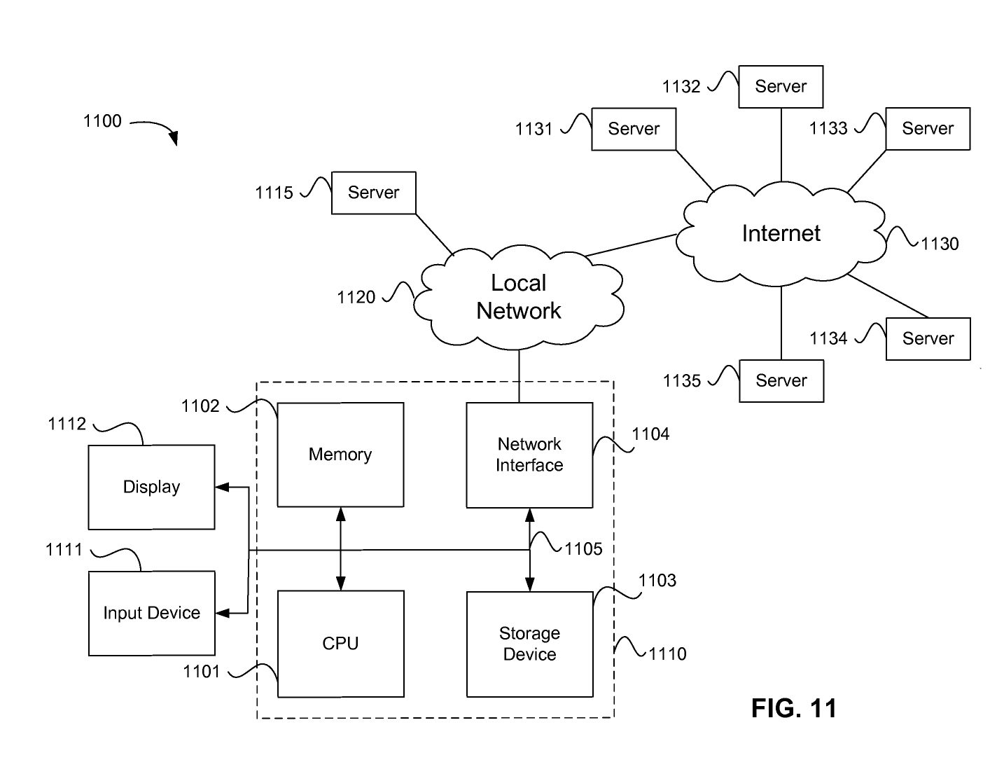

An exemplary computer system 1100 is illustrated in FIG. 11. Computer system 1110 includes a bus 1105 or other communication mechanism for communicating information, and a processor 1101 coupled with bus 1105 for processing information. Computer system 1110 also includes a memory 1102 coupled to bus 1105 for storing information and instructions to be executed by processor 1101, including information and instructions for performing the techniques described above, for example. This memory may also be used for storing variables or other intermediate information during execution of instructions to be executed by processor 1101. Possible implementations of this memory may be, but are not limited to, random access memory (RAM), read only memory (ROM), or both. A storage device 1103 is also provided for storing information and instructions. Common forms of storage devices include, for example, a hard drive, a magnetic disk, an optical disk, a CD-ROM, a DVD, a flash memory, a USB memory card, or any other medium from which a computer can read. Storage device 1103 may include source code, binary code, or software files for performing the techniques above, for example. Storage device and memory are both examples of computer readable mediums.

Computer system 1110 may be coupled via bus 1105 to a display 1112, such as a cathode ray tube (CRT) or liquid crystal display (LCD), for displaying information to a computer user. An input device 1111 such as a keyboard and/or mouse is coupled to bus 1105 for communicating information and command selections from the user to processor 1101. The combination of these components allows the user to communicate with the system. In some systems, bus 1105 may be divided into multiple specialized buses.

Computer system 1110 also includes a network interface 1104 coupled with bus 1105. Network interface 1104 may provide two-way data communication between computer system 1110 and the local network 1120. The network interface 1104 may be a digital subscriber line (DSL) or a modem to provide data communication connection over a telephone line, for example. Another example of the network interface is a local area network (LAN) card to provide a data communication connection to a compatible LAN. Wireless links are another example. In any such implementation, network interface 1104 sends and receives electrical, electromagnetic, or optical signals that carry digital data streams representing various types of information.

Computer system 1110 can send and receive information, including messages or other interface actions, through the network interface 1104 across a local network 1120, an Intranet, or the Internet 1130. For a local network, computer system 1110 may communicate with a plurality of other computer machines, such as server 1115. Accordingly, computer system 1110 and server computer systems represented by server 1115 may form a cloud computing network, which may be programmed with processes described herein. In the Internet example, software components or services may reside on multiple different computer systems 1110 or servers 1131-1135 across the network. The processes described above may be implemented on one or more servers, for example. A server 1131 may transmit actions or messages from one component, through Internet 1130, local network 1120, and network interface 1104 to a component on computer system 1110. The software components and processes described above may be implemented on any computer system and send and/or receive information across a network, for example.

The above description illustrates various embodiments of the present invention along with examples of how aspects of the present invention may be implemented. The above examples and embodiments should not be deemed to be the only embodiments, and are presented to illustrate the flexibility and advantages of the present invention as defined by the following claims. Based on the above disclosure and the following claims, other arrangements, embodiments, implementations and equivalents will be evident to those skilled in the art and may be employed without departing from the spirit and scope of the invention as defined by the claims.

What is claimed is:

1. A computer-implemented method, comprising:
calculating, by the processor, a score for a causal attribute based on raw customer data associated with a customer, the causal attribute belonging to a collection of causal attributes that include at least one of an advocacy attribute, a satisfaction attribute, a branding attribute, and a new value creation attribute;
updating, by the processor, a multidimensional customer relationship model that is associated with the customer with the calculated score for the causal attribute, the multidimensional customer relationship model being configured to store the collection of causal attributes;
calculating, by the processor, a customer relationship score based on the collection of causal attributes of the multidimensional customer relationship model; and
storing, by the processor, the customer relationship score in the multidimensional customer relationship model.

2. The computer-implemented method of claim 1, wherein the causal attribute is the advocacy attribute and calculating the score for the causal attribute comprises:
analyzing, by the processor, at least one of the following parameters from the raw customer data to generate an advocacy score:
a first number of a references provided by the customer,
a second number of testimonials provided by the customer,
a third number of case studies published by the customer, and
a fourth number of speaker invitations accepted by the customer.

3. The computer-implemented method of claim 2, wherein calculating the score for the causal attribute further comprises weighting the score based on a tier level associated with the customer.

4. The computer-implemented method of claim 1, wherein the causal attribute is the satisfaction attribute and calculating the score for the causal attribute comprises:
analyzing, by the processor, at least one of the following parameters from the customer raw data to generate a satisfaction score:
a satisfaction survey associated with the customer,
at least one complaint submitted by the customer, and
at least one risk score associated with a phase of a project associated with the customer.

5. The computer-implemented method of claim 4, wherein the risk score is weighted based on a severity state of a risk and the duration of the risk.

6. The computer-implemented method of claim 1, further comprising:
determining, by the processor, a revenue received from the customer; and
providing, by the processor, a recommended action based on the customer relationship score of the multidimensional customer relationship model and the revenue.

7. The computer-implemented method of claim 1, further comprising:
determining, by the processor, that the customer relationship score is above a predefined threshold;
identifying, by the processor, a plurality of prospective customers that are connected with the customer; and
providing, by the processor, a recommended action to request the customer advocate a service to at least one of the plurality of prospective customers.

8. A non-transitory computer readable storage medium storing one or more programs, the one or more programs comprising instructions for:
calculating a score for a causal attribute based on raw customer data associated with a customer, the causal attribute belonging to a collection of causal attributes that include at least one of an advocacy attribute, a satisfaction attribute, a branding attribute, and a new value creation attribute;
updating a multidimensional customer relationship model that is associated with the customer with the calculated score for the causal attribute, the multidimensional customer relationship model being configured to store the collection of causal attributes;
calculating a customer relationship score based on the collection of causal attributes of the multidimensional customer relationship model; and
storing the customer relationship score in the multidimensional customer relationship model.

9. The non-transitory computer readable storage medium of claim 8, wherein the causal attribute is the advocacy attribute and calculating the score for the causal attribute comprises:
analyzing at least one of the following parameters from the raw customer data to generate an advocacy score:
a first number of a references provided by the customer,
a second number of testimonials provided by the customer,
a third number of case studies published by the customer, and
a fourth number of speaker invitations accepted by the customer.

10. The non-transitory computer readable storage medium of claim 9, wherein calculating the score for the causal attribute further comprises weighting the score based on a tier level associated with the customer.

11. The non-transitory computer readable storage medium of claim 8, wherein the causal attribute is the satisfaction attribute and calculating the score for the causal attribute comprises:
analyzing at least one of the following parameters from the customer raw data to generate a satisfaction score:
a satisfaction survey associated with the customer,
at least one complaint submitted by the customer, and
at least one risk score associated with a phase of a project associated with the customer.

12. The non-transitory computer readable storage medium of claim 11, wherein the risk score is weighted based on a severity state of a risk and the duration of the risk.

13. The non-transitory computer readable storage medium of claim 8, further comprising:
determining a revenue received from the customer; and
providing a recommended action based on the customer relationship score of the multidimensional customer relationship model and the revenue.

14. The non-transitory computer readable storage medium of claim 8, further comprising:
determining that the customer relationship score is above a predefined threshold;
identifying a plurality of prospective customers that are connected with the customer; and
providing a recommended action to request the customer advocate a service to at least one of the plurality of prospective customers.

15. A computer implemented system, comprising:
one or more computer processors; and
a non-transitory computer-readable storage medium comprising instructions, that when executed, control the one or more computer processors to be configured for:
calculating a score for a causal attribute based on raw customer data associated with a customer, the causal attribute belonging to a collection of causal attributes that include at least one of an advocacy attribute, a satisfaction attribute, a branding attribute, and a new value creation attribute;
updating a multidimensional customer relationship model that is associated with the customer with the calculated score for the causal attribute, the multidimensional customer relationship model being configured to store the collection of causal attributes;
calculating a customer relationship score based on the collection of causal attributes of the multidimensional customer relationship model; and
storing the customer relationship score in the multidimensional customer relationship model.

16. The computer implemented system of claim 15, wherein the causal attribute is the advocacy attribute and calculating the score for the causal attribute comprises:
analyzing at least one of the following parameters from the raw customer data to generate an advocacy score:
a first number of a references provided by the customer,
a second number of testimonials provided by the customer,
a third number of case studies published by the customer, and
a fourth number of speaker invitations accepted by the customer.

17. The computer implemented system of claim 16, wherein calculating the score for the causal attribute further comprises weighting the score based on a tier level associated with the customer.

18. The computer implemented system of claim 15, wherein the causal attribute is the satisfaction attribute and calculating the score for the causal attribute comprises:
analyzing at least one of the following parameters from the customer raw data to generate a satisfaction score:
a satisfaction survey associated with the customer,
at least one complaint submitted by the customer, and
at least one risk score associated with a phase of a project associated with the customer.

19. The computer implemented system of claim 18, wherein the risk score is weighted based on a severity state of a risk and the duration of the risk.

20. The computer implemented system of claim 15, further comprising:
determining that the customer relationship score is above a predefined threshold;
identifying a plurality of prospective customers that are connected with the customer; and
providing a recommended action to request the customer advocate a service to at least one of the plurality of prospective customers.
